(19) United States
(12) Patent Application Publication
(10) Pub. No.: US 2020/0181381 A1
(43) Pub. Date: Jun. 11, 2020

(54) RUBBER COMPOSITION HAVING COATING FILM AFFINITY AND EXTERNAL DIAPHRAGM FOR RAILROAD CARS

(71) Applicant: Sumitomo Riko Company Limited, Komaki-shi (JP)

(72) Inventor: Keiichi Muratani, Komaki-shi (JP)

(73) Assignee: Sumitomo Riko Company Limited, Komaki-shi (JP)

(21) Appl. No.: 16/785,895

(22) Filed: Feb. 10, 2020

Related U.S. Application Data
(63) Continuation of application No. PCT/JP2018/028448, filed on Jul. 30, 2018.

(30) Foreign Application Priority Data
Aug. 31, 2017 (JP) 2017-166463

(51) Int. Cl. C08L 23/16; C08F 136/06; C08L 23/26; C08K 3/22; C08K 5/14; B61D 17/22

(52) U.S. Cl. CPC C08L 23/16; C08F 136/06; C08L 23/26; C08K 3/22; C08L 2205/03; B61D 17/22; C08K 2003/2224; C08K 2003/2227; C08L 2312/02; C08K 5/14

(57) ABSTRACT

Provided is a rubber composition having coating film affinity, including the following component (A) as a main component, and the following components (B) and (C). Also provided is an external diaphragm for railroad cars, including a cross-linked product of the rubber composition having coating film affinity. The rubber composition having coating film affinity can exhibit excellent performance as a material for forming a rubber product (a rubber product, such as an external diaphragm for railroad cars) required to have coating film adhesion as well as rubber physical properties, such as tensile strength and breaking elongation, and durability.
(A) An ethylene-propylene-diene rubber (EPDM)
(B) A non-hydrogenated liquid butadiene rubber having a functional group capable of reacting with at least one selected from the group consisting of an isocyanate group and a hydroxy group
(C) An organic peroxide cross-linking agent

### RELATED APPLICATION

This application is a continuation of International Application No. PCT/JP2018/028448, filed on Jul. 30, 2018, which claims priority to Japanese Patent Application No. 2017-166463, filed on Aug. 31, 2017, the entire contents of each of which being hereby incorporated by reference.

### TECHNICAL FIELD

The present disclosure relates to a rubber composition having coating film affinity to be used as a material for a rubber product having high coating film affinity, and to an external diaphragm for railroad cars obtained using the rubber composition having coating film affinity.

### BACKGROUND ART

An external diaphragm is arranged between railroad cars (in a car connecting portion) mainly for the purposes of, for example, preventing a person from falling off a platform into a space portion formed between cars of a train, and reducing air resistance of the connecting portion between cars. As such external diaphragm for railroad cars, there is used, for example, a rubber-made external diaphragm formed of an ethylene-propylene-diene rubber (EPDM) or the like (see, for example, Patent Literature 1).

Incidentally, a coating is often applied to a surface of the external diaphragm for railroad cars. However, the external diaphragm formed of the EPDM is poor in coating film affinity because the EPDM is a non-polar rubber. Accordingly, when the coating is applied as described above, adhesion between the rubber and the coating film is difficult to secure.

Therefore, hitherto, the adhesion of the coating film has been secured on the basis of an anchoring effect of surface preparation involving polishing the surface of the external diaphragm.

### RELATED ART DOCUMENT

### Patent Document

PTL 1: JP-B2-4853485

### SUMMARY

However, the external diaphragm for railroad cars is large and has a complicated shape, and hence is liable to have polishing non-uniformity when polished as described above. This causes the adhesion of the coating film to be unstable, and hence a problem arises in that peeling of the coating film occurs at the time of actual use of the external diaphragm.

Meanwhile, there is also known a method involving applying a primer having affinity for both a rubber and a coating material to the surface of a rubber product in advance to enhance mutual adhesiveness. However, when the primer is applied to a rubber product that is large and has a complicated shape like the external diaphragm for railroad cars, application non-uniformity is liable to occur. Further, there may also arise a problem in that a primer coating film undergoes plastic deformation without following the bending of the external diaphragm, and the primer coating film undergoes interfacial peeling from the deformed portion as an origin.

On the other hand, there is also known a method involving subjecting the surface of a rubber product to chemical treatment or activated gas treatment, to thereby enhance adhesiveness between a rubber and a coating film. However, such treatment of a large rubber product like the external diaphragm for railroad cars entails a problem of an increase in cost due to equipment investment, gas measures, or the like.

In view of the foregoing, an investigation has also been made on adding a component for enhancing coating film affinity into a material for a rubber product to enhance the adhesion of a coating film to the rubber product. At present, however, a sufficient investigation has yet to be made on, for example, a technology for enhancing the adhesion of the coating film while securing rubber physical properties, such as tensile strength and breaking elongation, and durability as required of the external diaphragm for railroad cars.

The present disclosure has been made in view of such circumstances, and relates to a rubber composition having coating film affinity that can exhibit excellent performance as a material for forming a rubber product required to have coating film adhesion as well as rubber physical properties, such as tensile strength and breaking elongation, and durability, and to an external diaphragm for railroad cars obtained using the rubber composition having coating film affinity.

A first gist of the present disclosure resides in a rubber composition having coating film affinity, including the following component (A) as a main component, and the following components (B) and (C):

(A) an ethylene-propylene-diene rubber (EPDM);

(B) a non-hydrogenated liquid butadiene rubber having a functional group capable of reacting with at least one selected from the group consisting of an isocyanate group and a hydroxy group; and

(C) an organic peroxide cross-linking agent.

A second gist of the present disclosure resides in an external diaphragm for railroad cars, including a cross-linked product of the rubber composition having coating film affinity of the first gist.

A third gist of the present disclosure resides in an external diaphragm for railroad cars, including: a cross-linked product of the rubber composition having coating film affinity of the first gist; and a urethane coating film or an acrylic coating film, coating a surface of the cross-linked product.

That is, the inventor has made extensive investigations in order to solve the above-mentioned problems. During the course of the investigations, the inventor has considered adding a polymer having a polar group into a rubber composition containing the EPDM, which is a non-polar rubber, as a main component, to express coating film affinity by virtue of the polar group. Then, as a result of various experiments, the inventor has ascertained that, when a modified polymer obtained by modifying a liquid butadiene rubber so as to have, at an end or the like of the liquid butadiene rubber, a functional group capable of reacting with an isocyanate group (—NCO), such as a hydroxy group, or a functional group capable of reacting with a hydroxy group, is used as the polymer having a polar group, a coating material applied to the surface of a rubber product that is a cross-linked product of the rubber composition shows stable coating film adhesion without impairing the rubber physical properties of the rubber product. A possible reason for this is as described below. A hydrophobic moiety of the modified polymer shows high compatibility with the EPDM, and besides, the functional group of the modified polymer is non-compatible with the EPDM, and hence is precipitated on the surface of the cross-linked product of the rubber composition. The functional group has reacted with the coating material (e.g., an isocyanate group of a urethane coating material) applied to the surface of the rubber product, with the result that the stable coating film adhesion as described above has been able to be secured. Further, when the liquid butadiene rubber is non-hydrogenated, the liquid butadiene rubber contains a large amount of a highly reactive 1,2-vinyl structure, and hence the 1,2-vinyl structure serves as a cross-linking point to cause co-cross-linking with the EPDM via the organic peroxide cross-linking agent. Thus, rubber physical properties required of an external diaphragm for railroad cars or the like can be secured. The inventor has found that, for the above-mentioned reason, the liquid butadiene rubber plays a role in flexibly binding to a coating film without undergoing bleeding or the like, and as a result, the desired object can be achieved.

As described above, the rubber composition having coating film affinity of the present disclosure includes the EPDM (A), the non-hydrogenated liquid butadiene rubber (B) having a functional group capable of reacting with at least one selected from the group consisting of an isocyanate group and a hydroxy group, and the organic peroxide cross-linking agent (C). Accordingly, the rubber composition having coating film affinity of the present disclosure can exhibit excellent performance as a material for forming a rubber product required to have coating film adhesion as well as rubber physical properties, such as tensile strength and breaking elongation, and durability. Accordingly, the rubber composition having coating film affinity of the present disclosure can exhibit excellent performance particularly as a material for forming a cover, such as an external diaphragm for railroad cars.

In particular, when a content of the specific non-hydrogenated liquid butadiene rubber (B) falls within a range of from 10 parts by weight to 30 parts by weight with respect to 100 parts by weight of the EPDM (A), the coating film affinity can be further enhanced.

In addition, when the rubber composition having coating film affinity includes a metal hydroxide (D) at a ratio of from 100 parts by weight to 400 parts by weight with respect to 100 parts by weight of the EPDM (A), a flame retardant effect required of an external diaphragm for railroad cars or the like can be obtained.

Further, when the metal hydroxide (D) includes at least one selected from the group consisting of aluminum hydroxide and magnesium hydroxide, a more excellent flame retardant effect can be obtained.

In addition, the external diaphragm for railroad cars formed of the cross-linked product of the rubber composition having coating film affinity of the present disclosure as described above is excellent in rubber physical properties, such as tensile strength and breaking elongation, and durability, and also exhibits an excellent effect on coating film adhesion.

In addition, when the external diaphragm for railroad cars includes the cross-linked product of the rubber composition having coating film affinity of the present disclosure, and the urethane coating film or acrylic coating film coating the surface of the cross-linked product, the adhesion between the rubber that is the cross-linked product and the coating film is further enhanced, and hence a more excellent coating film adhesion effect is obtained.

### DESCRIPTION OF EMBODIMENTS

Next, embodiments of the present disclosure are described in detail.

As described above, a rubber composition having coating film affinity of the present disclosure (hereinafter abbreviated as “rubber composition of the present disclosure”) includes: an EPDM (A) as a main component; a non-hydrogenated liquid butadiene rubber (B) having a functional group capable of reacting with at least one selected from the group consisting of an isocyanate group and a hydroxy group; and an organic peroxide cross-linking agent (C). Accordingly, the rubber composition of the present disclosure can exhibit excellent performance as a material for forming a rubber product required to have coating film adhesion as well as rubber physical properties, such as tensile strength and breaking elongation, and durability. The rubber composition of the present disclosure can exhibit excellent performance particularly as a material for forming a cover, such as an external diaphragm for railroad cars. In the present disclosure, the “main component” is a component that significantly affects the properties of the rubber composition of the present disclosure, and generally means 55 wt. % or more of the entirety of the rubber composition of the present disclosure. In addition, “non-hydrogenated” in the component (B) is intended to exclude an intentionally hydrogenated liquid butadiene rubber. In addition, by being “liquid”, the component (B) is meant to be a butadiene rubber showing a viscosity of 1,000 Pa·s or less at normal temperature (23° C.)

<<EPDM (Component A)>>

The EPDM (A) to be used for the rubber composition of the present disclosure is obtained by copolymerizing a diene monomer (third component) together with ethylene and propylene. The diene monomer is preferably a diene monomer having 5 to 20 carbon atoms, and specific examples thereof include 1,4-pentadiene, 1,4-hexadiene, 1,5-hexadiene, 2,5-dimethyl-1,5-hexadiene, 1,4-octadiene, 1,4-cyclohexadiene, cyclooctadiene, dicyclopentadiene (DCP), 5-ethylidene-2-norbornene (ENB), 5-butylidene-2-norbornene, 2-methacryl-5-norbornene, and 2-isopropenyl-5-norbornene. Of those diene monomers (third component), dicyclopentadiene (DCP) and 5-ethylidene-2-norbornene (ENB) are preferred.

As required, an ethylene-propylene copolymer rubber (EPM) may be used as a blend with the EPDM.

<<Non-Hydrogenated Liquid Butadiene Rubber Having Functional Group Capable of Reacting with at Least One Selected from the Group Consisting of Isocyanate Group and Hydroxy Group (Component B)>>

The non-hydrogenated liquid butadiene rubber (B) having a functional group capable of reacting with at least one selected from the group consisting of an isocyanate group and a hydroxy group to be used for the rubber composition of the present disclosure is preferably a non-hydrogenated liquid butadiene rubber having the functional group at each of both ends of a molecular chain thereof from the viewpoint of coating film affinity. Examples of the functional group include a hydroxy group, a maleic acid group, an epoxy group, a carboxylic acid group, an amine group, and an acrylic group. The liquid butadiene rubber may have one kind or a plurality of kinds out of the above-mentioned various functional groups in one molecule thereof. Further, when the functional group is a hydroxy group, the hydroxyl value of the liquid butadiene rubber is preferably from 20 mgKOH/g to 70 mgKOH/g from the viewpoint of coating film affinity. In addition, the liquid butadiene rubber may be a product obtained by subjecting a double bond in a molecular chain of a butadiene rubber to an addition reaction, such as hydrogenation, as long as, as described above, the liquid butadiene rubber is not intentionally hydrogenated. However, the double bond (in particular, a double bond of a 1,2-vinyl structure) serves as a cross-linking point with the EPDM, and hence a reduction in the number of the cross-linking points through hydrogenation or the like adversely affects rubber physical properties. Therefore, the addition reaction, such as hydrogenation, of the double bond in the molecular chain of the butadiene rubber should be limited to a slight amount, and a hydrogenation rate of 0% is desired. The hydrogenation rate of the liquid butadiene rubber indicates the ratio of a block structure having no double bond in the molecular structure of the liquid butadiene rubber, and is calculated on the basis of the ratio of each structural unit measured by ¹H-NMR. In addition, the ratio of a 1,2-vinyl structure in the molecular chain of the liquid butadiene rubber is preferably from 20% to 90% from the viewpoint of enhancing co-cross-linking with the EPDM. It is preferred from the viewpoint of co-cross-linking with the EPDM that the ratio of a cis-1,4-butadiene structure in the molecular chain of the liquid butadiene rubber be from 0% to 20%, and the ratio of a trans-1,4-butadiene structure therein be from 10% to 60%.

In addition, the viscosity at normal temperature (23° C.) of the non-hydrogenated liquid butadiene rubber (B) having a functional group capable of reacting with at least one selected from the group consisting of an isocyanate group and a hydroxy group is preferably from 1 Pa·s to 40 Pa·s from the viewpoint of achieving high compatibility with the EPDM without causing bleeding or reductions in rubber physical properties. The viscosity is a value measured using a B-type viscometer in conformity with JIS K 7117.

Further, the number average molecular weight (Mn) of the non-hydrogenated liquid butadiene rubber (B) having a functional group capable of reacting with at least one selected from the group consisting of an isocyanate group and a hydroxy group is preferably from 500 to 5,000, and more preferably falls within the range of from 1,000 to 3,000. Such number average molecular weight is preferred from the viewpoint of achieving high compatibility with the EPDM without causing bleeding or reductions in rubber physical properties. The number average molecular weight (Mn) is a value measured in accordance with gel permeation chromatography (GPC).

The content of the non-hydrogenated liquid butadiene rubber (B) having a functional group capable of reacting with at least one selected from the group consisting of an isocyanate group and a hydroxy group falls within preferably the range of from 10 parts by weight to 30 parts by weight, more preferably the range of from 10 parts by weight to 25 parts by weight, still more preferably the range of from 10 parts by weight to 20 parts by weight with respect to 100 parts by weight of the EPDM (A). That is, such range is adopted because of the following reasons: when the content of the non-hydrogenated liquid butadiene rubber (B) is excessively low, the specific functional group for expressing coating film affinity cannot be sufficiently introduced into the rubber; and when the content of the non-hydrogenated liquid butadiene rubber (B) is excessively high, there is observed such a tendency that the rubber physical properties, such as tensile strength, and durability are reduced.

<<Organic Peroxide Cross-Linking Agent (Component C)>>

Examples of the organic peroxide cross-linking agent (C) to be used for the rubber composition of the present disclosure include 2,4-dichlorobenzoyl peroxide, benzoyl peroxide, 1,1-di-t-butylperoxy-3,3,5-trimethylcyclohexane, 2,5-dimethyl-2,5-dibenzoylperoxyhexane, n-butyl-4,4′-di-t-butyl peroxyvalerate, dicumyl peroxide, t-butyl peroxybenzoate, di-t-butylperoxy-diisopropylbenzene, t-butyl cumyl peroxide, 2,5-dimethyl-2,5-di-t-butylperoxyhexane, di-t-butyl peroxide, 2,5-dimethyl-2,5-di-t-butylperoxyhexyne-3, and 1,3-bis-(t-butylperoxy-isopropyl)benzene. Those cross-linking agents may be used alone or in combination thereof. In the present disclosure, the organic peroxide is used as the cross-linking agent as described above, and hence co-cross-linking between the non-hydrogenated liquid butadiene rubber (B) having a small molecular weight and the EPDM (A) can be satisfactorily achieved. In addition, when the organic peroxide is used as the cross-linking agent as described above, a problem of, for example, yellowing due to acid rain can be eliminated.

The content of the organic peroxide cross-linking agent (C) falls within preferably the range of from 0.5 parts by weight to 15 parts by weight, more preferably the range of from 0.5 parts by weight to 10 parts by weight with respect to 100 parts by weight of the EPDM (A). That is, such range is adopted because of the following reasons: when the content of the cross-linking agent is excessively low, there is observed such a tendency that tensile strength is reduced; and when the content of the cross-linking agent is excessively high, there is observed such a tendency that scorch resistance is deteriorated and breaking elongation is reduced.

As required, a metal hydroxide (component D), an acid-modified polyolefin, a reinforcing agent (e.g., carbon black, silica, or talc), a vulcanization accelerator, a vulcanization aid, a co-cross-linking agent, an anti-aging agent, a process oil, and the like may be appropriately blended into the rubber composition of the present disclosure in addition to the components (A) to (C).

<<Metal Hydroxide (Component D)>>

At least one selected from the group consisting of aluminum hydroxide and magnesium hydroxide is preferably used as the metal hydroxide (D) from the viewpoint of obtaining a flame retardant effect required of an external diaphragm for railroad cars or the like.

In addition, the rubber composition of the present disclosure contains as an essential component the non-hydrogenated liquid butadiene rubber (B) having a functional group capable of reacting with at least one selected from the group consisting of an isocyanate group and a hydroxy group, and hence exhibits the following effect: its processability is not impaired even when the metal hydroxide (D) is added thereto in a large amount. The content of the metal hydroxide (D) falls within preferably the range of from 100 parts by weight to 400 parts by weight, more preferably the range of from 100 parts by weight to 250 parts by weight with respect to 100 parts by weight of the EPDM (A). When the metal hydroxide (D) is added in a large amount as described above, an excellent flame retardant effect can be obtained.

<<Acid-Modified Polyolefin>>

An example of the acid-modified polyolefin is an acid-modified polyolefin obtained by acid-modifying a polyolefin resin, such as poly-α-olefin, high-density polyethylene (HDPE), polyethylene, polypropylene, polybutene, or polymethylpentene. Those acid-modified polyolefins may be used alone or in combination thereof. The acid modification is performed with, for example, an unsaturated carboxylic acid, polylactic acid, phosphoric acid, or a sulfonic acid. In addition, examples of the unsaturated carboxylic acid include acrylic acid, methacrylic acid, maleic acid, maleic anhydride, itaconic acid, itaconic anhydride, fumaric acid, crotonic acid, a half ester of an unsaturated dicarboxylic acid, a half amide of an unsaturated dicarboxylic acid, phthalic acid, cinnamic acid, glutaconic acid, citraconic anhydride, aconitic anhydride, and nadic acid. In addition, a modifying group resulting from the above-mentioned acid modification may be present at an end of the molecular chain of the polyolefin, or may be present in the middle of the molecular chain (at a non-end position of the molecular chain).

Of those, the acid-modified polyolefin is preferably a maleic acid-modified polyolefin from the viewpoint of, for example, the dispersibility of the metal hydroxide, and is more preferably a maleic acid-modified poly-α-olefin from a similar viewpoint.

In addition, the content of the acid-modified polyolefin falls within preferably the range of from 5 parts by weight to 30 parts by weight, more preferably the range of from 5 parts by weight to 20 parts by weight with respect to 100 parts by weight of the EPDM (A). That is, such range is adopted because, when the content of the acid-modified polyolefin is excessively high, the rubber physical properties and durability of the EPDM may be adversely affected.

The rubber composition of the present disclosure may be prepared, for example, in the following manner. That is, the EPDM (A) and the non-hydrogenated liquid butadiene rubber (B) having a functional group capable of reacting with at least one selected from the group consisting of an isocyanate group and a hydroxy group are blended, and as required, the metal hydroxide (D), the acid-modified polyolefin, the reinforcing agent, the anti-aging agent, the process oil, and the like are appropriately further blended. With the use of a Banbury mixer or the like, kneading of those components is started at a temperature of about 50° C., followed by kneading at from 100° C. to 160° C. for from about 3 minutes to about 5 minutes. Next, the kneaded product is appropriately blended with the organic peroxide cross-linking agent (C), the co-cross-linking agent, the vulcanization accelerator, the vulcanization aid, and the like, followed by kneading using an open roll under predetermined conditions (e.g., 60° C.×5 minutes). Thus, the rubber composition may be prepared. After that, the resultant rubber composition may be cross-linked at a high temperature (of from 150° C. to 170° C.) for from 5 minutes to 60 minutes to provide a rubber product (cross-linked product).

The rubber composition of the present disclosure can exhibit excellent performance particularly as a material for forming a cover, such as an external diaphragm for railroad cars. An example of the cover other than the external diaphragm for railroad cars is a soft top for an automobile. In addition, an external diaphragm for railroad cars including a cross-linked product of the rubber composition of the present disclosure is excellent in rubber physical properties, such as tensile strength and breaking elongation, and durability, and also exhibits an excellent effect on coating film adhesion. Accordingly, satisfactory coating film adhesion can be secured without performing surface preparation, such as polishing processing, and hence a contribution can be made to the simplification of a production process.

In addition, the cross-linked product of the rubber composition of the present disclosure has high coating film adhesion as described above. Particularly for a coating film such as a urethane coating film or an acrylic coating film, an adhesion effect between the rubber that is the cross-linked product and the coating film is further enhanced through a reaction between the functional group (e.g., hydroxy group) on the surface of the cross-linked product and the coating film.

### EXAMPLES

Next, Examples are described together with Comparative Examples. However, the present disclosure is not limited to these Examples.

First, prior to the Examples and Comparative Examples, the following materials were prepared.

[EPDM (Component A)]

ESPRENE 512F, manufactured by Sumitomo Chemical Co., Ltd.

[Acid-Modified Polyolefin]

TAFMER MH7020, manufactured by Mitsui Chemicals, Inc.

[Zinc Oxide]

Zinc Oxide No. 2, manufactured by Sakai Chemical Industry Co., Ltd.

[Stearic Acid]

Stearic acid “Sakura”, manufactured by NOF Corporation

[Aluminum Hydroxide (Component D)]

HIGILITE H-42M, manufactured by Showa Denko K.K.

[Liquid Butadiene Rubber-1 (Component B)]

Non-hydrogenated liquid butadiene rubber having a hydroxy group (hydroxyl value: 35 mgKOH/g to 55 mgKOH/g, hydrogenation rate: 0%, ratio of a 1,2-vinyl structure in a molecular chain: 85%, Mn: 2,000) (G-2000, manufactured by Nippon Soda Co., Ltd.)

[Liquid Butadiene Rubber-2 (Component B)]

Non-hydrogenated liquid butadiene rubber having an epoxy group (epoxy equivalent: 210 g/eq, hydrogenation rate: 0%, ratio of a 1,2-vinyl structure in a molecular chain: 70% or more, Mn: 1,300) (JP-100, manufactured by Nippon Soda Co., Ltd.)

[Liquid Butadiene Rubber-3 (Component B)]

Non-hydrogenated liquid butadiene rubber having a maleic acid group (acid value: 120 mgKOH/g, hydrogenation rate: 0%, ratio of a 1,2-vinyl structure in a molecular chain: 28%, Mn: 3,000) (Ricon 130 MA 20, manufactured by Cray Valley)

[Liquid Butadiene Rubber-4 (Component B)]

Non-hydrogenated liquid butadiene rubber having an acrylic group (acrylic equivalent: 1,400 g/eq, hydrogenation rate: 0%, ratio of a 1,2-vinyl structure inamolecularchain: 88%, Mn: 2,500) (TE-2000, manufactured by Nippon Soda Co., Ltd.)

[Liquid Butadiene Rubber-5]

Hydrogenated liquid butadiene rubber having a hydroxy group (hydroxy value: 40 mgKOH/g to 55 mgKOH/g, hydrogenation rate: 90% or more, ratio of a 1,2-vinyl structure in a molecular chain: 7% or less, Mn: 2,000) (GI-2000, manufactured by Nippon Soda Co., Ltd.)

[Peroxide Cross-Linking Agent (Component C)]

Percumyl D-40, manufactured by NOF Corporation

[Co-Cross-Linking Agent]

Hi-Cross ED-P, manufactured by Seiko Chemical Co., Ltd.

[Sulfur]

Sulfur, manufactured by Karuizawa Refinery

[Vulcanization Accelerator-1]

SANCELER BZ, manufactured by Sanshin Chemical Industry Co., Ltd.

[Vulcanization Accelerator-2]

SANCELER TT, manufactured by Sanshin Chemical Industry Co., Ltd.

[Vulcanization Accelerator-3]

SANCELER TRA, manufactured by Sanshin Chemical Industry Co., Ltd.

[Vulcanization Accelerator-4]

VULNOC R, manufactured by Ouchi Shinko Chemical Industrial Co., Ltd.

### Examples 1 to 8 and Comparative Examples 1 to 3

Components shown in Table 1 and Table 2 below were blended at ratios shown in Table 1 and Table 2, and were kneaded using a Banbury mixer and an open roll to prepare rubber compositions.

The evaluations of respective properties were performed by using the rubber compositions of the Examples and Comparative Examples thus obtained in accordance with the following criteria. The results are also shown in Table 1 and Table 2 below.

[Processability]

The Mooney viscosity of each of the rubber compositions (kneaded products) was measured at a test temperature of 121° C. in conformity with JIS K6300-1 (2001). Then, a case in which the Mooney viscosity (ML₁₊₄ 121° C.) was 60 or less was evaluated as excellent (indicated by Symbol “0”), and a case in which the Mooney viscosity was more than 60 was evaluated as poor (indicated by Symbol “x”).

[Tensile Strength and Breaking Elongation]

Each of the rubber compositions was subjected to press molding (vulcanized) under the conditions of 150° C.×20 minutes to produce a rubber sheet having a thickness of 2 mm. Then, a JIS No. 5 dumbbell was punched out of the rubber sheet, and its tensile strength and elongation at break (breaking elongation) were measured in conformity with JIS K6251 (2010). A case in which the tensile strength was 10 MPa or more was evaluated as excellent (indicated by Symbol “o”), and a case in which the tensile strength was less than 10 MPa was evaluated as poor (indicated by Symbol “x”). In addition, a case in which the breaking elongation was 500% or more was evaluated as excellent (indicated by Symbol “o”), and a case in which the breaking elongation was 400% or more and less than 500% was evaluated as good (indicated by Symbol “Δ”).

[Dumbbell Fatigue Test]

Each of the rubber compositions was subjected to press molding (vulcanized) under the conditions of 150° C.×20 minutes to produce a rubber sheet having a thickness of 2 mm. Then, a JIS No. 3 dumbbell was punched out of the rubber sheet, and a dumbbell fatigue test (elongation test) was performed by using the dumbbell inconformity with JIS K6260. Then, such a dumbbell that the number of times of elongation at the time of its breaking (number of times at the time of the breaking) was 30,000 or more was evaluated as excellent (indicated by Symbol “0”), and such a dumbbell that the number of times at the time of the breaking was less than 30,000 was evaluated as poor (indicated by Symbol “x”).

[Coating Material Adhesion]

Each of the rubber compositions was subjected to press molding (vulcanized) under the conditions of 170° C.×20 minutes to produce a rubber sheet having a thickness of 2 mm. Then, a urethane coating material (POLITAN, manufactured by Dai Nippon Toryo Co., Ltd.) was applied to the surface of the rubber sheet to form a urethane coating film having a thickness of 50 μm, and then a JIS No. 1 dumbbell was punched out of the rubber sheet. After that, the dumbbell was subjected to a tensile test, and a case in which peeling of the urethane coating film was not observed even when the elongation ratio of the dumbbell exceeded 200% was evaluated as excellent (indicated by Symbol “o”), and a case in which peeling of the urethane coating film was observed when the elongation ratio of the dumbbell was 200% or less was evaluated as poor (indicated by Symbol “x”).

[Light Permeability Test]

Each of the rubber compositions was subjected to press molding (vulcanized) under the conditions of 170° C.×60 minutes to produce a 76.2-millimeter square rubber block having a thickness of 25.4 mm. Then, in order for the flame retardancy of the rubber block to be evaluated, the light permeability of smoke produced at the time of the combustion of the rubber block was measured in conformity with ASTM E662. That is, such a rubber block that the Ds value (specific optical density) of the smoke 4 minutes after the initiation of heating in a non-flaming or flaming test was less than 50 was evaluated as excellent (indicated by Symbol “o”).

[Oxygen Index]

Each of the rubber compositions was subjected to press molding (vulcanized) under the conditions of 170° C.×20 minutes to produce a rubber sheet having a thickness of 2 mm. Then, in order to evaluate how burnable the rubber sheet was, the lowest oxygen concentration (vol. %) required for sustaining the combustion of the rubber sheet was measured in conformity with JIS K7201. Then, a case in which the oxygen index was 24 or more was evaluated as excellent (indicated by Symbol “o”), and a case in which the oxygen index was 21 or more and less than 24 was evaluated as good (indicated by Symbol “Δ”).

TABLE 1
(Parts by weight)

| | Example | | | | | | | |
|---|---|---|---|---|---|---|---|---|
| | 1 | 2 | 3 | 4 | 5 | 6 | 7 | 8 |
| EPDM | 95.0 | 95.0 | 95.0 | 95.0 | 95.0 | 95.0 | 95.0 | 95.0 |
| Acid-modified polyolefin | 5.0 | 5.0 | 5.0 | 5.0 | 5.0 | 5.0 | 5.0 | 5.0 |
| Zinc oxide | 5.0 | 5.0 | 5.0 | 5.0 | 5.0 | 5.0 | 5.0 | 5.0 |
| Stearic acid | 2.0 | 2.0 | 2.0 | 2.0 | 2.0 | 2.0 | 2.0 | 2.0 |
| Aluminum hydroxide | 150.0 | 150.0 | 150.0 | 150.0 | 150.0 | 150.0 | 150.0 | 150.0 |
| Liquid butadiene rubber-1 | 10.0 | 15.0 | 20.0 | 25.0 | 30.0 | — | — | — |
| Liquid butadiene rubber-2 | — | — | — | — | — | 10.0 | — | — |
| Liquid butadiene rubber-3 | — | — | — | — | — | — | 10.0 | — |
| Liquid butadiene rubber-4 | — | — | — | — | — | — | — | 10.0 |
| Liquid butadiene rubber-5 | — | — | — | — | — | — | — | — |
| Peroxide cross-linking agent | 4.0 | 4.0 | 4.0 | 4.0 | 4.0 | 4.0 | 4.0 | 4.0 |
| Co-cross-linking agent | 5.0 | 5.0 | 5.0 | 5.0 | 5.0 | 5.0 | 5.0 | 5.0 |
| Sulfur | — | — | — | — | — | — | — | — |
| Vulcanization accelerator-1 | — | — | — | — | — | — | — | — |
| Vulcanization accelerator-2 | — | — | — | — | — | — | — | — |
| Vulcanization accelerator-3 | — | — | — | — | — | — | — | — |
| Vulcanization accelerator-4 | — | — | — | — | — | — | — | — |
| Processability | ∘ | ∘ | ∘ | ∘ | ∘ | ∘ | ∘ | ∘ |
| Tensile strength | ∘ | ∘ | ∘ | ∘ | ∘ | ∘ | ∘ | ∘ |
| Breaking elongation | ∘ | ∘ | ∘ | ∘ | Δ | ∘ | ∘ | ∘ |
| Dumbbell fatigue test | ∘ | ∘ | ∘ | ∘ | ∘ | ∘ | ∘ | ∘ |
| Coating material adhesion | ∘ | ∘ | ∘ | ∘ | ∘ | ∘ | ∘ | ∘ |
| Light permeability test | ∘ | ∘ | ∘ | ∘ | ∘ | ∘ | ∘ | ∘ |
| Oxygen index | ∘ | ∘ | ∘ | ∘ | Δ | ∘ | ∘ | ∘ |

TABLE 2
(Parts by weight)

| | Comparative Example | | |
|---|---|---|---|
| | 1 | 2 | 3 |
| EPDM | 95.0 | 95.0 | 95.0 |
| Acid-modified polyolefin | 5.0 | 5.0 | 5.0 |
| Zinc oxide | 5.0 | 5.0 | 5.0 |
| Stearic acid | 2.0 | 2.0 | 2.0 |
| Aluminum hydroxide | 150.0 | 150.0 | 150.0 |
| Liquid butadiene rubber-1 | — | 10.0 | — |
| Liquid butadiene rubber-2 | — | — | — |
| Liquid butadiene rubber-3 | — | — | — |
| Liquid butadiene rubber-4 | — | — | — |
| Liquid butadiene rubber-5 | — | — | 20.0 |
| Peroxide cross-linking agent | 4.0 | — | 4.0 |
| Co-cross-linking agent | 5.0 | — | 5.0 |
| Sulfur | — | 0.6 | — |
| Vulcanization accelerator-1 | — | 0.5 | — |
| Vulcanization accelerator-2 | — | 0.5 | — |
| Vulcanization accelerator-3 | — | 1.5 | — |
| Vulcanization accelerator-4 | — | 1.7 | — |
| Processability | x | ∘ | ∘ |
| Tensile strength | ∘ | x | x |
| Breaking elongation | ∘ | ∘ | ∘ |
| Dumbbell fatigue test | ∘ | ∘ | x |
| Coating material adhesion | x | ∘ | ∘ |
| Light permeability test | ∘ | ∘ | ∘ |
| Oxygen index | ∘ | ∘ | ∘ |

It is found from the results shown in Table 1 that the rubber compositions of the Examples are excellent in processability at the time of kneading, and rubber physical properties, such as tensile strength and breaking elongation, and also excellent in durability (dumbbell fatigue test), and have also received high evaluations in coating material adhesion. The rubber compositions of the Examples have also received high evaluations in the flame retardancy evaluations (light permeability test and oxygen index).

In contrast, the rubber composition of Comparative Example 1, which contained no component corresponding to the non-hydrogenated liquid butadiene rubber (component B) having a functional group capable of reacting with at least one selected from the group consisting of an isocyanate group and a hydroxy group, had inferior results in processability and coating material adhesion to those of the rubber compositions of the Examples. The rubber composition of Comparative Example 2 was cross-linked with sulfur without containing the peroxide cross-linking agent (component C), and hence had an inferior result in tensile strength. The rubber composition of Comparative Example 3 contained no component corresponding to the non-hydrogenated liquid butadiene rubber (component B) having a functional group capable of reacting with at least one selected from the group consisting of an isocyanate group and a hydroxy group, and contained the hydrogenated liquid butadiene rubber having a hydroxy group, and hence did not obtain sufficient cross-linking points with the EPDM (component A), leading to inferior results in tensile strength and the dumbbell fatigue test to those of the rubber compositions of the Examples.

Although specific embodiments of the present disclosure have been described in the Examples above, the Examples above are for illustrative purposes only and are not to be construed as limitative. It is intended that various modifications apparent to a person skilled in the art fall within the scope of the present disclosure.

The rubber composition of the present disclosure exhibits excellent effects on rubber physical properties, such as tensile strength and breaking elongation, and durability, and also exhibits an excellent effect on coating film adhesion. Accordingly, the rubber composition of the present disclosure can exhibit excellent performance particularly as a material for forming a cover, such as an external diaphragm for railroad cars. In addition to the external diaphragm for railroad cars, the rubber composition of the present disclosure can be used as, for example, a material for forming a soft top for an automobile or the like, or a material for forming any other rubber product required to have a coating thereon.

1. A rubber composition having coating film affinity, comprising the following component (A) as a main component, and the following components (B) and (C):
(A) an ethylene-propylene-diene rubber;
(B) a non-hydrogenated liquid butadiene rubber having a functional group capable of reacting with at least one selected from the group consisting of an isocyanate group and a hydroxy group; and
(C) an organic peroxide cross-linking agent.

2. The rubber composition having coating film affinity according to claim 1, wherein a content of the non-hydrogenated liquid butadiene rubber (B) having a functional group capable of reacting with at least one selected from the group consisting of an isocyanate group and a hydroxy group falls within a range of from 10 parts by weight to 30 parts by weight with respect to 100 parts by weight of the ethylene-propylene-diene rubber (A).

3. The rubber composition having coating film affinity according to claim 1, further comprising the following component (D) at a ratio of from 100 parts by weight to 400 parts by weight with respect to 100 parts by weight of the ethylene-propylene-diene rubber (A):
(D) a metal hydroxide.

4. The rubber composition having coating film affinity according to claim 3, wherein the metal hydroxide (D) comprises at least one selected from the group consisting of aluminum hydroxide and magnesium hydroxide.

5. The rubber composition having coating film affinity according to claim 1, wherein the rubber composition having coating film affinity comprises a rubber composition for a cover.

6. An external diaphragm for railroad cars, comprising a cross-linked product of the rubber composition having coating film affinity of claim 1.

7. An external diaphragm for railroad cars, comprising:
a cross-linked product of the rubber composition having coating film affinity of claim 1; and
a urethane coating film or an acrylic coating film, coating a surface of the cross-linked product.

8. The rubber composition having coating film affinity according to claim 1, wherein the non-hydrogenated liquid butadiene rubber (B) having a functional group capable of reacting with at least one selected from the group consisting of an isocyanate group and a hydroxy group contains a 1,2-vinyl structure at a ratio of from 20% to 90% in a molecular chain thereof.

9. The rubber composition having coating film affinity according to claim 1, wherein the non-hydrogenated liquid butadiene rubber (B) having a functional group capable of reacting with at least one selected from the group consisting of an isocyanate group and a hydroxy group has a number average molecular weight (Mn) of from 500 to 5,000.

10. The rubber composition having coating film affinity according to claim 1, further comprising an acid-modified polyolefin.

11. The rubber composition having coating film affinity according to claim 10, wherein a content of the acid-modified polyolefin falls within a range of from 5 parts by weight to 30 parts by weight with respect to 100 parts by weight of the ethylene-propylene-diene rubber (A).

12. The rubber composition having coating film affinity according to claim 10, wherein the acid-modified polyolefin comprises a maleic acid-modified polyolefin.
